(19) United States
(12) Patent Application Publication
(10) Pub. No.: US 2026/0145465 A1
(43) Pub. Date: May 28, 2026

(54) TIRE TREAD DEPTH INDICATOR AND METHOD OF MAKING AND USING

(71) Applicant: Omni United (S) Pte Ltd., Singapore (SG)

(72) Inventor: Gajendra Singh Sareen, Singapore (SG)

(73) Assignee: Omni United (S) Pte Ltd., Singapore (SG)

(21) Appl. No.: 19/131,734

(22) PCT Filed: Sep. 18, 2024
(86) PCT No.: PCT/SG2024/050596

§ 371 Date: May 21, 2025

Related U.S. Application Data
(60) Provisional application No. 63/539,763, filed on Sep. 21, 2023.

(51) Int. Cl. B60C 11/24; B29D 30/06

(52) U.S. Cl. CPC B60C 11/24; B29D 30/0606; B29D 2030/0612

(57) ABSTRACT

A tire tread depth indicator molded into a tire tread surface provides a visually measurable indication of wear of tire tread depth for a vehicle tire. The tread depth indicator has a cog shape with a plurality of depth indicator teeth distributed equally around the cog shape and each of the depth indicator teeth has a depth corresponding to a tread depth measurement. The graduated depth of the tire tread depth indicator sequentially wears down at a rate that corresponds to the wear of the tire tread. A molding element and a method of using the molding element according to the invention forms a tire tread depth indicator having a cog shape with plurality of graduated height indicator teeth and segments distributed around the cog shape molded into a tire tread surface and provides an accurate visual measurement of tire tread depth over time of use.

### CROSS REFERENCE TO RELATED APPLICATIONS

This application claims the benefit of U.S. Provisional Application No. 63/539,763, filed Sep. 21, 2023.

### STATEMENT REGARDING FEDERALLY SPONSORED RESEARCH OR DEVELOPMENT

Not applicable.

### TECHNICAL FIELD OF INVENTION

The present invention is directed to a tire tread depth indicator positioned on a tire tread surface.

### BACKGROUND OF THE INVENTION

Tire tread designs possess structural elements that are meant to improve the performance and safety of the tire. Tread blocks or block elements on a tire tread design are raised tread elements that are constructed with either continuous ribs of repeating tread elements or circumferentially adjacent individual tread blocks. Grooves on a tire tread design surround the tire tread block elements, and the grooves usually extend circumferentially around the tire and laterally between the tire tread block elements. Some tread deigns include sipes which are thin grooves molded or cut into the surface of the tread blocks. Each of these tread elements have a defined purpose in a tire tread pattern and the overall design of tread blocks, ribs, grooves, and sipes work together to provide functional features specific to the intended use of the tire, such as type of weather or terrain where the tire is to be used.

Over time, tire tread structural elements are worn down from contacting road surfaces during driving. As the tire tread wears down, the raised tread block surfaces reduce in height causing a reduction in the depth between the tread block surface and the grooves. When the tread elements become worn and the depth between the tread blocks and the grooves is significantly reduced, the ability of the tire to grip the road and to provide traction in wet conditions decreases. Eventually the damaged tread can cause the tires to lose traction on the road, becoming a dangerous situation for the driver and any passengers in the vehicle. For this reason, users should inspect tires regularly to make certain adequate tread depth remains on the tires.

One way to test for tread depth is the “penny test.” A U.S. penny is inserted into the tire's tread groove with Lincoln's head upside down and facing out. If all of Lincoln's head is visible, the tread depth is less than 2/32 inch indicating the tires need to be replaced. While this may be an easy test, it does not provide an accurate means of monitoring the tire tread over time. Another way to test the tire tread depth is using a tread depth gauge. A tread depth gauge may be able to provide a more accurate measurement; however, a tread depth gauge may not always be readily available, and if used improperly, a tread depth gauge may lead to an incorrect reading of the tread depth.

What is needed is a tread depth indicator feature molded into the tire tread allowing for easy visual inspection that can accurately gauge the wear to the tire tread depth over time.

### SUMMARY OF THE INVENTION

Disclosed herein is a vehicle tire comprising a tire tread (100) covering a portion of the vehicle tire, the tire tread (100) having: a vertical tread depth extending from the lower base surface of the vehicle tire (105) to the upper tire tread surface (103A), said tire surface (103A) making contact of the tire tread (100) with street surfaces during normal use on the vehicle tire; characterized in that: the tire tread (100) having a visual tread depth indicator (101) defined by a first and a second vertical boundary wall (301) that surrounds a groove pattern (300), said groove pattern (300) having a bottom surface (302A-C) extending from the bottom of the first and second vertical boundary walls (301) to the top surface of first and second vertical boundary walls (203), said bottom surface (302A-C) having an incremental depth (204) extending from the upper tire tread surface (205) toward the lower base surface of the vehicle tire (207), and said groove pattern (300) having a plurality of indicator teeth marks (301A-F) positioned on said groove pattern (300), at least two of said indicator teeth marks sharing the same position on the groove pattern (803A, 863A) but indicating different tread depths for the tire tread (100) based on presence or absence of other indicator teeth marks (813A, 823A, 833A, 843A, 853A) on the groove pattern (300).

The vehicle tire tread (100) is a visual tread depth indicator (101) and the plurality of indicator teeth marks (813A, 823A, 833A, 843A, 853A) wear away sequentially in a clockwise direction beginning immediately adjacent to a clockwise side edge of a first indicator tooth mark (803A) having a first depth when all indicator teeth (803A-863A) are present, proceeding around the tread depth indicator to the first indicator tooth mark (863A) having a second depth when only the first indicator tooth (863A) is present on the tire tread surface. Each of the indicator teeth marks (803A-863A) have a specified depth determinative of a tire tread depth.

The invention disclosed herein is a tire tread depth indicator comprising a cog shaped indicator having incrementally descending height interior walls with a plurality of depth indicator teeth distributed around the indicator cog perimeter. The indicator cog has a first depth indicator tooth in a first cog position that gauges multiple tread depths and one or more subsequent depth indicator teeth determinative of specified tread depths positioned equidistant around the indicator cog perimeter, and the tire tread depth indicator is molded into one or more raised tread elements on a tire tread surface.

The disclosed tire tread depth indicator cog has a plurality of cog segments contiguous to the plurality of depth indicator teeth, the cog segments having vertical interior walls that incrementally increase in depth spirally around a circumference of the indicator cog, with the vertical interior wall material being substantially of the same material as the tire tread material. The cog segments and the depth indicator teeth wear away sequentially around the indicator cog as the raised tread element wears away with the tread depth indicator decreasing in height at the same rate as the raised tread element.

The tire tread depth indicator on a new tire is a full cog shape with the plurality of cog segments and depth indicator teeth visible. The sequential wear begins adjacent to the first depth indicator tooth, the first depth indicator tooth having a first tread depth measurement, and with wear proceeding around the circumference of the indicator cog. The cog segments and the subsequent depth indicator teeth disappear sequentially around the indicator cog until only the first depth indicator tooth is visible on the tire tread surface, and the first depth indicator tooth corresponding to a second tread depth measurement.

As disclosed herein, the tread depth indicator cog shape is a half of a hollow full cylindrical shell with an incrementally descending height inner wall having a plurality of gradient gauge marks distributed around the shell for visual measurement of tread depth The shell has a perimeter with a curved surface area of the cylindrical shell incrementally decreasing from the full height of the interior wall, and the gradient gauge marks being depth indicator teeth having a depth that is contiguous with the incrementally descending height inner walls.

In the disclosed tread depth indicator, the indicator cog segments and the depth indicator teeth wear away sequentially in a clockwise direction beginning immediately adjacent to a clockwise side edge of the first depth indicator tooth in the first cog position proceeding around the indicator cog back to the first depth indicator tooth in the first cog position, with one cog segment and one subsequent depth indicator tooth disappearing for every one millimeter of tire tread depth lost to wear. The tread depth indicator has six depth indicator teeth equally distributed around the circumference of the indicator cog and six cog segments contiguous to the depth indicator teeth around the circumference of the indicator cog, each of the depth indicator teeth having a specified depth determinative of a tire tread depth. The first depth indicator tooth has a first depth of 8 mm when a full indicator cog is visible on the tire tread surface and a second depth of 2 mm when only the first depth indicator tooth of the indicator cog is visible on the tire tread surface after the raised tread element has substantially worn away.

Each of the subsequent depth indicator teeth have a specified depth determinative of a tire tread depth with the specified depth of the subsequent depth indicator teeth being between the 2 mm and 8 mm depths of the fist depth indicator tooth.

Disclosed is a molding element for a tread depth indicator comprising a tread depth indicator forming member (700), said tread depth indicator forming member (700) defined by vertical boundary walls (707, 708, 709) having a plurality of indicator teeth marks (701-706) positioned on a groove pattern base (710), said indicator teeth incrementally increasing in height from a shortest indicator tooth (702) to a tallest indicator tooth (701), and said vertical boundary walls (707, 708, 709) incrementally increasing in height around said tread depth forming member (700) from an edge of said tallest indicator tooth (701) around the perimeter of the groove pattern base (710) in the direction of the adjacent indicator teeth (702-706) meeting back at the indicator tooth (701), said boundary walls increase in height being contiguous with the adjacent indicator teeth (701-706).

The boundary walls (707, 708, 709) of the tread indicator forming member incrementally increase in height in a clockwise direction around the groove pattern base (710), and said indicator tooth forming members increase in height by 1 mm in a clockwise direction around the groove pattern base (710), such that when the tread depth indicator and tread depth indictor teeth are molded into a raised tread element on a tire tread surface, each of the molded indicator teeth increases in depth by 1 mm and each molded segment of the boundary wall incrementally increases in depth consistent with the depth of the adjacent molded indicator teeth in a clockwise direction around the tread depth indicator. The tread depth indicator forming member (700) is positioned on a tread block molding sector on an interior mold face for molding a tread pattern onto a tire tread surface.

Also disclosed herein is a molding element for molding a tire tread depth indicator into a tire tread surface having a tread depth indicator forming member with a cylindrical shape and with an incrementally increasing height outer wall with a plurality of gradient gauge marks distributed around the tread depth indicator. The tread depth indicator forming member is a raised solid molding element that forms a cog shaped tread depth indicator having a plurality of depth indicator teeth distributed around the perimeter of the indicator cog. The tire tread depth indicator forming member has six indicator teeth distributed around a circumference of the indicator cog and six cog wall segments contiguous to the six indicator teeth around the circumference of the indicator cog molding element.

The wall segments of the disclosed indicator cog forming member incrementally increase in height in a clockwise direction around the indicator cog, and each depth indicator tooth forming member increases in height by 1 mm in a clockwise direction around the indicator cog, such that when the tread depth indicator is molded into the raised tread element surface, each of the indicator teeth increases in depth by 1 mm and each segment of the wall incrementally increases in depth in a clockwise direction around the tread depth indicator. The one or more tread depth indicator forming members and one or more tread pattern forming members for the tread pattern mold are made by engraving, casting, or metal additive manufacturing of the molding elements, or by other suitable mold element forming processes. The tread depth indicator forming member is positioned on one or more raised tread block molding sectors on an interior mold face for molding a tread pattern onto a tire tread surface.

Disclosed is also a method of molding a tire tread depth indicator into a tire tread surface. The method has the steps of providing a tire tread mold having an interior mold face, the mold face having a plurality of raised tread pattern forming members, and a plurality of tread block sectors, with the raised tread pattern forming members defining one or more sidewalls for the tread block sectors in a tread pattern mold and providing one or more raised tread depth indicator forming members, the tread depth indicator forming members having a cylindrical shape with an incrementally increasing height outer wall with a plurality of gradient gauge marks distributed around the tread depth indicator, with the tread depth indicator forming member being a raised solid molding element positioned in a central area of one or more tread block sectors on the interior mold face of the tread pattern mold. The method has the steps of fitting a tire curing and vulcanization apparatus with the tread pattern mold having said one or more tread depth indicator forming members positioned therein; providing an assembled uncured tire having an unmolded tread surface; and placing the assembled uncured tire in the curing and vulcanization apparatus fitted with the tread pattern mold having the one or more tread depth indicator forming members.

The method continues with applying a prescribed amount of heat and pressure to the uncured tire via the curing and vulcanization apparatus for a sufficient amount of time to mold the tread pattern with the tread depth indicator onto the tread surface of the tire resulting in a cured tire with the tread pattern of grooves and raised tread blocks around the circumference of a finished tire and having one or more tread depth indicator molded into a raised tread block on the surface of the finished tire, the tire tread depth indicator visually appearing on the raised tread block surface as a cog shape having one or more indicator teeth distributed around the cog; and then removing the finished tire from the curing and vulcanization apparatus.

In the disclosed method, the tire tread depth indicator forming member has six depth indicator teeth distributed around a circumference of the indicator cog shape and six cog wall segments contiguous to the six depth indicator teeth around the circumference of the indicator cog shape. The indicator cog forming member wall segments incrementally increase in height in a clockwise direction around the cog, and each depth indicator tooth forming member increases in height by 1 mm in a clockwise direction around the indicator cog, such that when the tread depth indicator is molded into the tread block surface, each of the depth indicator teeth increases in depth by 1 mm and each cog segment of the wall incrementally increases in depth in a clockwise direction around the tread depth indicator. The tread pattern forming members and the tread depth indicator forming members for the tread pattern mold are made by engraving, casting, or metal additive manufacturing of the molding elements.

The tire tread depth indicator can be used to determine a tread depth of a tire by mounting a new or unused tire to a motor vehicle, with the tire having a tire tread pattern with one or more tire tread depth indicators molded into one or more tread blocks. The tread depth indicator visually appears as a cog shape coplanar with a surface of the tread block, and the cog shape has a gradually increasing wall depth with a plurality of depth indicator teeth distributed equally around the indicator cog and plurality of cog segments contiguous to the depth indicator teeth. The tire tread pattern and the tread depth indicator on the tire is viewed and the user visually determines the number of cog segments and depth indicator teeth visible on the tread block surface, wherein the greater the number of cog segments and depth indicator teeth visible, the greater the remaining depth of the tire tread. The tire tread depth is assessed based on the visual determination of the number of cog segments and depth indicator teeth on the tire tread depth indicator.

The tread depth indicator positioned in the tread block wears away at the same rate as the tread block, and the cog segments and depth indicator teeth disappear sequentially in a clockwise direction around the indicator cog. The tread depth indicator has six cog segments and six indicator teeth positioned around the tread depth indicator cog, each indicator tooth having a depth corresponding to a measurement of tread depth and each cog segment incrementally increases in depth in a clockwise direction around a circumference of the indicator cog.

### BRIEF DESCRIPTION OF THE DRAWINGS

The above, and other objects and advantages of the present invention will be understood upon consideration of the following detailed description taken in conjunction with the accompanying drawings, in which like reference characters refer to like parts throughout, and in which:

FIG. 1 shows a top view of the tread indicator on a new tire with no wear through the tread depth.

FIG. 2 shows an unfolded view of the tread depth indicator tube.

FIG. 3 shows a folded view of the tread depth indicator tube.

FIG. 4 shows a comparison of measurements on the folded and unfolded tread depth indicator.

FIG. 5 shows the height/depth of the indicator teeth on the unfolded shape

FIG. 6A shows the indicator shape with spacing of teeth.

FIG. 6B shows the tread depth indicator teeth measurements.

FIG. 7 shows the tread depth indicator mold.

FIG. 8A. shows the tread depth indicator with the full 8 mm depth.

FIG. 8B shows the tread depth indicator with 7 mm depth remaining.

FIG. 8C shows the tread depth indicator with 6 mm depth remaining.

FIG. 8D shows the tread depth indicator with 5 mm depth remaining.

FIG. 8E shows the tread depth indicator with 4 mm depth remaining.

FIG. 8F shows the tread depth indicator with 3 mm depth remaining.

FIG. 8G shows the tread depth indicator with 2 mm depth remaining.

FIG. 8H shows the tread depth indicator with 1 mm or less depth remaining.

FIG. 9 shows a comparison of the wear cycle on the tread depth indicator.

### DETAILED DESCRIPTION

The present invention is a tire tread depth indicator molded into a tire tread surface having a hollow cylindrical shell with an incrementally descending height outer wall with gradient gauge marks distributed around the shell. The tread depth indicator is a cog shape on a tire tread surface with a wall that gradually decreases in height around the circumference of the indicator cog with indicator teeth distributed along the cog wherein the indicator teeth incrementally decrease in height at the same rate as the circular indicator. The tread depth indicator is molded into a tire tread block and wears away at the same rate as the tire tread block. Each indicator tooth segment denotes a certain tread depth starting with a new tire having no wear to the tread or to the indicator cog or tread blocks with the subsequent indicator teeth demonstrating different levels of wear to the tread.

It is difficult and time consuming to evaluate or measure the remaining tread depth accurately. The present invention solves this problem. The tread depth indicator shows the remaining tread depth with a quick visual inspection of the tread. In one embodiment, a tread block or rib has a cog shaped figure when the tire is new. In other embodiments, the tread indicator may have other shapes, including but not limited to oval, triangle, diamond, square, and rectangle shapes. The tread depth indicator shape may be selected to coordinate with or contrast with the aesthetic design of the tread pattern.

Disclosed herein is a vehicle tire comprising a tire tread (100) covering a portion of the vehicle tire, the tire tread (100) having: a vertical tread depth extending from the lower base surface of the vehicle tire (105) to the upper tire tread surface (103A), said tire surface (103A) making contact of the tire tread (100) with street surfaces during normal use on the vehicle tire; characterized in that: the tire tread (100) having a visual tread depth indicator (101) defined by a first and a second vertical boundary wall (301) that surrounds a groove pattern (300), said groove pattern (300) having a bottom surface (302A-C) extending from the bottom of the first and second vertical boundary walls (301) to the top surface of first and second vertical boundary walls (203), said bottom surface (302A-C) having an incremental depth (204) extending from the upper tire tread surface (205) toward the lower base surface of the vehicle tire (207), and said groove pattern (300) having a plurality of indicator teeth marks (301A-F) positioned on said groove pattern (300), at least two of said indicator teeth marks sharing the same position on the groove pattern (803A, 863A) but indicating different tread depths for the tire tread (100) based on presence or absence of other indicator teeth marks (813A, 823A, 833A, 843A, 853A) on the groove pattern (300).

The vehicle tire tread (100) is a visual tread depth indicator (101) and the plurality of indicator teeth marks (813A, 823A, 833A, 843A, 853A) wear away sequentially in a clockwise direction beginning immediately adjacent to a clockwise side edge of a first indicator tooth mark (803A) having a first depth when all indicator teeth (803A-863A) are present, proceeding around the tread depth indicator to the first indicator tooth mark (863A) having a second depth when only the first indicator tooth (863A) is present on the tire tread surface. Each of the indicator teeth marks (803A-863A) have a specified depth determinative of a tire tread depth.

The invention disclosed herein is a tire tread depth indicator comprising a cog shaped indicator having incrementally descending height interior walls with a plurality of depth indicator teeth distributed around the indicator cog perimeter. The indicator cog has a first depth indicator tooth in a first cog position that gauges multiple tread depths and one or more subsequent depth indicator teeth determinative of specified tread depths positioned equidistant around the indicator cog perimeter, and the tire tread depth indicator is molded into one or more raised tread elements on a tire tread surface.

The disclosed tire tread depth indicator cog has a plurality of cog segments contiguous to the plurality of depth indicator teeth, the cog segments having vertical interior walls that incrementally increase in depth spirally around a circumference of the indicator cog, with the vertical interior wall material being substantially of the same material as the tire tread material. The cog segments and the depth indicator teeth wear away sequentially around the indicator cog as the raised tread element wears away with the tread depth indicator decreasing in height at the same rate as the raised tread element.

The tire tread depth indicator on a new tire is a full cog shape with the plurality of cog segments and depth indicator teeth visible. The sequential wear begins adjacent to the first depth indicator tooth, the first depth indicator tooth having a first tread depth measurement, and with wear proceeding around the circumference of the indicator cog. The cog segments and the subsequent depth indicator teeth disappear sequentially around the indicator cog until only the first depth indicator tooth is visible on the tire tread surface, and the first depth indicator tooth corresponding to a second tread depth measurement.

As disclosed herein, the tread depth indicator cog shape is a half of a hollow full cylindrical shell with an incrementally descending height inner wall having a plurality of gradient gauge marks distributed around the shell for visual measurement of tread depth The shell has a perimeter with a curved surface area of the cylindrical shell incrementally decreasing from the full height of the interior wall, and the gradient gauge marks being depth indicator teeth having a depth that is contiguous with the incrementally descending height inner walls.

In the disclosed tread depth indicator, the indicator cog segments and the depth indicator teeth wear away sequentially in a clockwise direction beginning immediately adjacent to a clockwise side edge of the first depth indicator tooth in the first cog position proceeding around the indicator cog back to the first depth indicator tooth in the first cog position, with one cog segment and one subsequent depth indicator tooth disappearing for every one millimeter of tire tread depth lost to wear. The tread depth indicator has six depth indicator teeth equally distributed around the circumference of the indicator cog and six cog segments contiguous to the depth indicator teeth around the circumference of the indicator cog, each of the depth indicator teeth having a specified depth determinative of a tire tread depth. The first depth indicator tooth has a first depth of 8 mm when a full indicator cog is visible on the tire tread surface and a second depth of 2 mm when only the first depth indicator tooth of the indicator cog is visible on the tire tread surface after the raised tread element has substantially worn away.

Each of the subsequent depth indicator teeth have a specified depth determinative of a tire tread depth with the specified depth of the subsequent depth indicator teeth being between the 2 mm and 8 mm depths of the fist depth indicator tooth.

Disclosed is a molding element for a tread depth indicator comprising a tread depth indicator forming member (700), said tread depth indicator forming member (700) defined by vertical boundary walls (707, 708, 709) having a plurality of indicator teeth marks (701-706) positioned on a groove pattern base (710), said indicator teeth incrementally increasing in height from a shortest indicator tooth (702) to a tallest indicator tooth (701), and said vertical boundary walls (707, 708, 709) incrementally increasing in height around said tread depth forming member (700) from an edge of said tallest indicator tooth (701) around the perimeter of the groove pattern base (710) in the direction of the adjacent indicator teeth (702-706) meeting back at the indicator tooth (701), said boundary walls increase in height being contiguous with the adjacent indicator teeth (701-706).

The boundary walls (707, 708, 709) of the tread indicator forming member incrementally increase in height in a clockwise direction around the groove pattern base (710), and said indicator tooth forming members increase in height by 1 mm in a clockwise direction around the groove pattern base (710), such that when the tread depth indicator and tread depth indictor teeth are molded into a raised tread element on a tire tread surface, each of the molded indicator teeth increases in depth by 1 mm and each molded segment of the boundary wall incrementally increases in depth consistent with the depth of the adjacent molded indicator teeth in a clockwise direction around the tread depth indicator. The tread depth indicator forming member (700) is positioned on a tread block molding sector on an interior mold face for molding a tread pattern onto a tire tread surface.

Also disclosed herein is a molding element for molding a tire tread depth indicator into a tire tread surface having a tread depth indicator forming member with a cylindrical shape and with an incrementally increasing height outer wall with a plurality of gradient gauge marks distributed around the tread depth indicator. The tread depth indicator forming member is a raised solid molding element that forms a cog shaped tread depth indicator having a plurality of depth indicator teeth distributed around the perimeter of the indicator cog. The tire tread depth indicator forming member has six indicator teeth distributed around a circumference of the indicator cog and six cog wall segments contiguous to the six indicator teeth around the circumference of the indicator cog molding element.

The wall segments of the disclosed indicator cog forming member incrementally increase in height in a clockwise direction around the indicator cog, and each depth indicator tooth forming member increases in height by 1 mm in a clockwise direction around the indicator cog, such that when the tread depth indicator is molded into the raised tread element surface, each of the indicator teeth increases in depth by 1 mm and each segment of the wall incrementally increases in depth in a clockwise direction around the tread depth indicator. The one or more tread depth indicator forming members and one or more tread pattern forming members for the tread pattern mold are made by engraving, casting, or metal additive manufacturing of the molding elements, or by other suitable mold element forming processes. The tread depth indicator forming member is positioned on one or more raised tread block molding sectors on an interior mold face for molding a tread pattern onto a tire tread surface.

Disclosed is also a method of molding a tire tread depth indicator into a tire tread surface. The method has the steps of providing a tire tread mold having an interior mold face, the mold face having a plurality of raised tread pattern forming members, and a plurality of tread block sectors, with the raised tread pattern forming members defining one or more sidewalls for the tread block sectors in a tread pattern mold and providing one or more raised tread depth indicator forming members, the tread depth indicator forming members having a cylindrical shape with an incrementally increasing height outer wall with a plurality of gradient gauge marks distributed around the tread depth indicator, with the tread depth indicator forming member being a raised solid molding element positioned in a central area of one or more tread block sectors on the interior mold face of the tread pattern mold. The method has the steps of fitting a tire curing and vulcanization apparatus with the tread pattern mold having said one or more tread depth indicator forming members positioned therein; providing an assembled uncured tire having an unmolded tread surface; and placing the assembled uncured tire in the curing and vulcanization apparatus fitted with the tread pattern mold having the one or more tread depth indicator forming members.

The method continues with applying a prescribed amount of heat and pressure to the uncured tire via the curing and vulcanization apparatus for a sufficient amount of time to mold the tread pattern with the tread depth indicator onto the tread surface of the tire resulting in a cured tire with the tread pattern of grooves and raised tread blocks around the circumference of a finished tire and having one or more tread depth indicator molded into a raised tread block on the surface of the finished tire, the tire tread depth indicator visually appearing on the raised tread block surface as a cog shape having one or more indicator teeth distributed around the cog; and then removing the finished tire from the curing and vulcanization apparatus.

In the disclosed method, the tire tread depth indicator forming member has six depth indicator teeth distributed around a circumference of the indicator cog shape and six cog wall segments contiguous to the six depth indicator teeth around the circumference of the indicator cog shape. The indicator cog forming member wall segments incrementally increase in height in a clockwise direction around the cog, and each depth indicator tooth forming member increases in height by 1 mm in a clockwise direction around the indicator cog, such that when the tread depth indicator is molded into the tread block surface, each of the depth indicator teeth increases in depth by 1 mm and each cog segment of the wall incrementally increases in depth in a clockwise direction around the tread depth indicator. The tread pattern forming members and the tread depth indicator forming members for the tread pattern mold are made by engraving, casting, or metal additive manufacturing of the molding elements.

The tire tread depth indicator can be used to determine a tread depth of a tire by mounting a new or unused tire to a motor vehicle, with the tire having a tire tread pattern with one or more tire tread depth indicators molded into one or more tread blocks. The tread depth indicator visually appears as a cog shape coplanar with a surface of the tread block, and the cog shape has a gradually increasing wall depth with a plurality of depth indicator teeth distributed equally around the indicator cog and plurality of cog segments contiguous to the depth indicator teeth. The tire tread pattern and the tread depth indicator on the tire is viewed and the user visually determines the number of cog segments and depth indicator teeth visible on the tread block surface, wherein the greater the number of cog segments and depth indicator teeth visible, the greater the remaining depth of the tire tread. The tire tread depth is assessed based on the visual determination of the number of cog segments and depth indicator teeth on the tire tread depth indicator.

The tread depth indicator positioned in the tread block wears away at the same rate as the tread block, and the cog segments and depth indicator teeth disappear sequentially in a clockwise direction around the indicator cog. The tread depth indicator has six cog segments and six indicator teeth positioned around the tread depth indicator cog, each indicator tooth having a depth corresponding to a measurement of tread depth and each cog segment incrementally increases in depth in a clockwise direction around a circumference of the indicator cog.

The tread depth indicator as seen on a tread block starts as an entire cog shape having indicator teeth distributed equally around the perimeter of the cog. As the tire tread starts to wear down, segments on the tread depth indicator cog gradually start disappearing in a clockwise manner indicating the wear on the tire tread. The tread indicator teeth are positioned at each even millimeter and help a user to understand the exact remaining tread depth. The cog of the tread depth indicator gradually disappears from the tread block and together with the measurement in millimeters (mm) associated with each of the indicator teeth gives a very accurate reading of the remaining tread depth.

Placement of the tire tread depth indicator along the tread pattern of the tire can also allow visual determination of uneven wear on the tires. If the tread depth indicators are not wearing at substantially the same rate for all of the surface or circumference of the tire, or if the wear is uneven between the tires, it may indicate that a tire is improperly mounted or may indicate a problem with either the tire, the balance, the tire pressure, or the vehicle axle assembly.

Accurate tread depth information helps to evaluate when tires should be replaced or for deciding if some tires should be replaced first. When making seasonal tire changes, accurate tread depth information helps in deciding which tires should be fitted to front and rear axles of the vehicle to maximize safety and/or to achieve as even wear as possible for all tires.

One embodiment of the tire tread indicator is half of a full cylindrical shell with a wall having a plurality of gradient gauge marks for visual measurement distributed around the perimeter of the shell. The curved surface area of the cylindrical shell incrementally decreases from the full height of the outer wall to being substantially coplanar with the tire surface as wear of the tire progresses. The outer wall material is substantially the same as the tire tread and has a volume, diameter, and thickness that prevents buckling of the outer wall under the pressure associated with the tire contacting a road surface.

The volume (V) of the outer wall of the cylindrical shell can be determined by the formula V=π(R²−r²)h, where R is the radius of the outer edge of the cylindrical shell, r is the radius of the inner edge of the cylindrical shell and h is the height of the cylindrical shell. This determines the volume of a full cylindrical shell, and the volume of the tire tread indicator's incrementally decreasing outer wall will be substantially one half of the volume of the full cylindrical shell.

The surface area (SA) of the outer wall of the cylindrical shell can be determined by the formula SA=2πrh, where r is the radius of the outer edge of the cylindrical shell and h is the height of the outer wall. The surface area of the tire tread indicator's incrementally decreasing outer wall will be substantially one half of the surface area of the full cylindrical shell.

Tire treads typically have a repeating pattern of tread blocks and grooves across and around the road contact surface of the tire. Tread blocks are raised segments on the tire that make contact with the road surface and often there are one or more ribs of tread blocks positioned at the centermost section of the tread surface running circumferentially around the tire tread surface. Grooves are deep channels between the tread blocks that run longitudinally around the circumference of the tire, and laterally across the tread tire creating a pattern with the tread blocks. Tread patterns may also have a pattern of sipes appearing as thin grooves across the surface of one or more of the tread blocks. The disclosed tread depth indicator is molded into one or more of the raised tread blocks to gauge the reduction in height of the tread block caused by contact with the road surface.

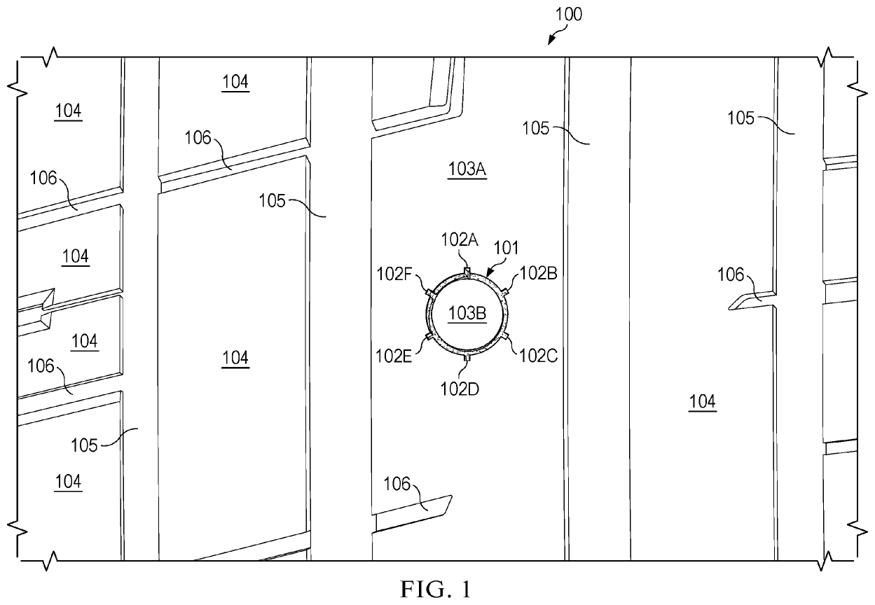

As described herein, measurements used in FIGS. 1-9 for the tread depth indicator and tire tread patterns are measurements in millimeters (mm) that would be commonly used on a passenger car tire, with a tread depth of about 8 mm ( 10/32- 11/32 inch) on a new tire and replacement of tires needed when the tread depth is about 1.6 mm ( 2/32 inch). For other types of vehicles, such as light trucks, heavy trucks and off-road vehicles, the required new tire tread depth may be greater than 8 mm and replacement may be needed when more than 1.6 mm of tire tread depth remains. The principles of use and manufacturer of the tire tread depth indicator described herein are equally applicable to other sizes and types of tires, and the depth of the tread depth indicator described herein can be constructed for other sizes and types of tires in the tread pattern molding process.

In FIG. 1, the tread depth indicator 100 is disposed in one of the centrally located tread blocks 103A and the top edge of the tread depth indicator cog 101 is coplanar with the tread block 103A. The tire tread pattern shown also has adjacent tread blocks 104, longitudinal grooves 105, and lateral grooves 106 distributed across the tread area of the tire.

FIG. 1 is a top view of the tread depth indicator as it would appear on a new tire. The tread depth indicator 100 as seen on the surface of a centrally located tread block 103A visually appears as a full indicator cog 101 having six indicator teeth 102A-102F evenly distributed around the indicator cog 101. The tread depth indicator shape is molded into one or more centrally located tread blocks on a tire and has a graduated depth that is not readily apparent when viewed from the surface of the tire. The material of tread block 103A forms the outer wall of the tread depth indicator cog 101 and tread block material 103B fills the center portion forming the inner wall of the tread depth indicator shape. The surface area of the tire tread indicator's incrementally decreasing outer wall will be substantially one half of the surface area of the full cylindrical shell of the tread depth indicator.

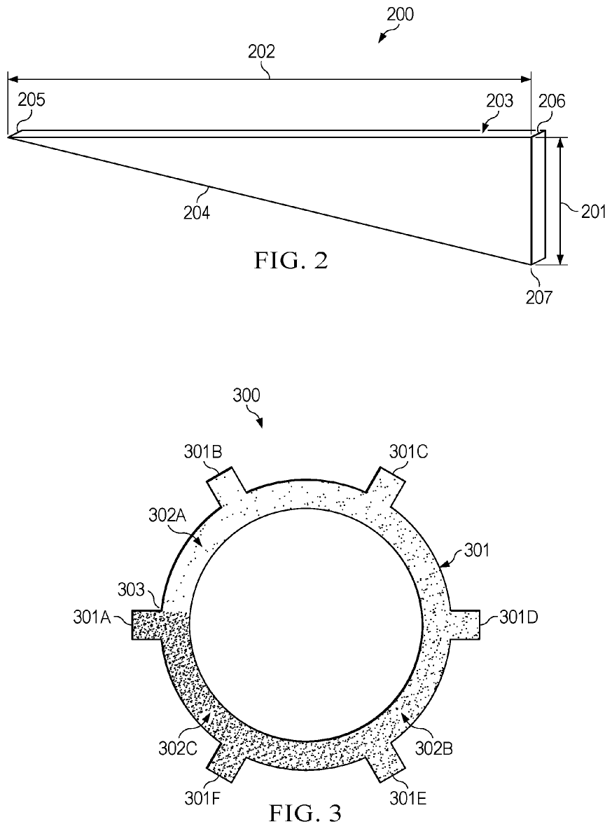

FIG. 2 shows how an unfolded tread depth indicator 200 would appear if the tubular design was unfolded into a flat triangular shape. The unfolded view is a planar view that visually relates positions of features on the three dimensional cog shaped indicator to the relative horizontal positions of the same features. The tread depth indicator shape has a vertical depth/height 201 and a top edge length 202. As seen at the top of the shape, the groove 203 has inner and outer vertical boundary walls for the tread depth indicator groove and defines the voided area that is visible when the tread depth indicator cog shape is viewed on a tire tread surface. The bottom edge of the groove 204 is graduated from the bottom edge 207 of the lower base area of the tire tread at the vertical depth/height 201 of the unfolded indicator view 200 upward to the shallow tube tip 205 at the upper tire tread surface of the unfolded indicator. As used with the cog shape on a tire tread, the tube tip 205 would be directly adjacent to the top edge 206 at the vertical depth/height 201 edge of the cog shape as visible on a tire tread surface.

FIG. 3 shows how the unfolded tread depth indicator of FIG. 2 appears when folded into the tubular cog shaped groover pattern 300 of the tread depth indicator. Indicator teeth 301A-301F are positioned equidistant around the indicator cog 301, the cog shape having boundary walls with each indicator tooth corresponding to a specified tread depth measurement. Indicator tooth 301A corresponds to the 8 mm depth of the tread depth indicator with the shallow tube tip 303 (205 in FIG. 2) of the tubular structure positioned on the tread surface immediately adjacent to the indicator tooth 301A such that the deepest segment of the tread depth indicator, indicator tooth 301A, is directly next to the shallowest segment of the indicator, at tube tip 303.

The graduated depth groove 302A-302C of the bottom surface is the groove arca that begins where the shallow tip 303 is positioned adjacent to the top edge of the 8 mm indicator tooth 301A. The groove gradually deepens in a clockwise direction around the cog back to the 8 mm indicator tooth 301A, which is the deepest point of the groove. The shallowest segment of the groove 302A is between the 8 mm indicator tooth 301A and the 7 mm indicator tooth 301B. The groove deepens as it progresses in a clockwise direction past the 6 mm indicator tooth 301C and the 5 mm indicator tooth 301D, and the groove depth has a midpoint at segment 302B between the 5 mm indicator tooth 301D and the 4 mm indicator tooth 301E. The deepest segment of the groove 302C is the segment between the 3 mm indicator tooth 301F and the 8 mm indicator tooth 301A. The groove gradually deepens by 1 mm between each of the indicator teeth.

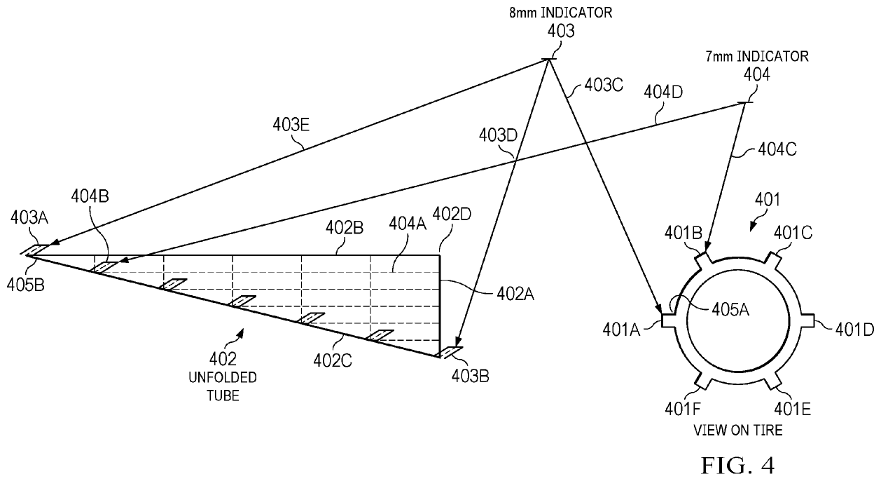

In FIG. 4, corresponding features of the tread depth indicator are identified on the folded tread depth indicator view 401 and the unfolded tread depth indicator view 402. The cog shape of the folded tread depth indicator view 401 has indicator teeth 401A-401F positioned around the cog shape. The indicator tooth 401A is at the 8 mm depth and the indicator tooth for 7 mm depth is 401B. For the remaining indicator teeth, 401C marks the 6 mm depth, 401D marks the 5 mm depth, 401E marks the 4 mm depth, and 401F marks the 3 mm depth.

The unfolded tread depth indicator 402 has a vertical edge depth/height 402A and a top horizontal edge 402B along its length. The vertical edge depth/height 402A shown here is 8 mm. The unfolded indicator view has a graduated bottom edge 402C. The top point 402D of the vertical edge depth/height 402A corresponds to the position where the tube tip 405B on the unfolded view is located on the cog shaped view 401.

The 8 mm indicator arrows 403 show the corresponding points for the 8 mm indicator tooth on the folded cog view 401 and the unfolded view 402 of the tread depth indicator. Arrow 403C points to the 8 mm indicator tooth 401A on folded shape 401. Arrow 403D points to the 8 mm depth point 403B on vertical edge depth/height 402A of the unfolded view 402. Arrow 403E points to the indicator tooth 403A on the unfolded view 402.

When the unfolded shape 402 is formed into the folded cog shape 401, the indicator tooth 403A at the tip of the unfolded view is at the top point 402D of the vertical edge depth/height 402A and will be contiguous with the 8 mm depth point 403B, such that the indicator tooth at the tube tip 403A and the indicator tooth at the 8 mm depth point 403B are two ends of the same indicator tooth at the vertical edge 402A. The tube tip 405B on the unfolded view corresponds to the tube tip location 405A on the folded indicator cog 401, and is immediately adjacent to the 8 mm indicator tooth 401A.

The 7 mm arrows 404 show the corresponding points for the 7 mm indicator tooth on the folded 401 and unfolded 402 views of the tread depth indicator. Arrow 404C points the 7 mm indicator tooth 401B on folded cog shape 401. Arrow 404D points to the 7 mm tooth 404B position on the unfolded view 402. The 7 mm depth line 404A corresponds to the depth position of the 7 mm indicator tooth. In use, as the tire tread thickness wears down, the shallowest segment of the folded cog shape, seen between indicator teeth 401A and 401B, will no longer be visible, and the 7 mm depth line 404A denotes there is a 1 mm reduction to the surface of the worn tread block having the tread depth indicator. This 1 mm surface reduction seen for tread block with the tread depth indicator would correspond to similar surface reduction to substantially all of the tread blocks across the tire tread surface.

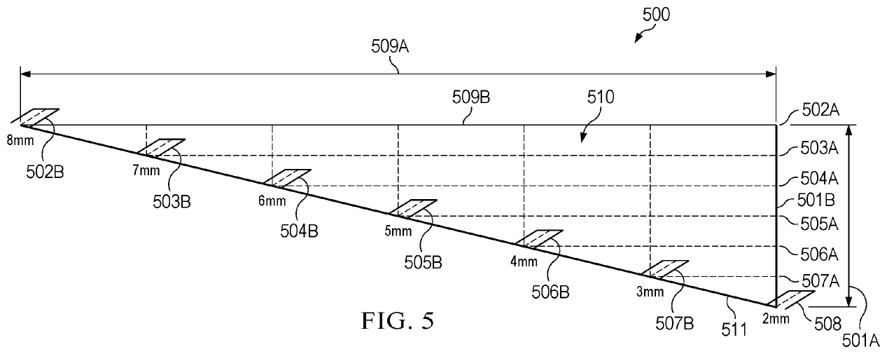

FIG. 5 is a more detailed view of the unfolded tread depth indicator 500. The unfolded shape has a length 509A for a horizontal top edge 509B and a depth/height 501A for a vertical edge 501B. Indicator teeth are marked with their related measurements on the graduated bottom edge 511 of the unfolded shape with the corresponding depth points marked on the vertical edge 501B of the unfolded shape. Graduated bottom edge 511 is graduated with respect to the horizontal top edge 509B. The dotted lines in the shape interior 510 indicate the location of each indicator tooth on the graduated bottom edge 511 with respect to the depth on the vertical edge 501B for the unfolded tread depth indicator 500. The full depth/height 501A is 8 mm for vertical edge 501B of the unfolded view of the tread depth indicator 500.

The 8 mm indicator mark 502A on the vertical edge 501B corresponds to the indicator tooth 502B at the tip of the unfolded shape where the horizontal top edge 509B meets with the graduated bottom edge 511 and corresponds to the shallowest point of the indicator. The 7 mm indicator mark 503A on the vertical edge 501B corresponds to the position of the 7 mm indicator tooth 503B on the graduated bottom edge 511. The 6 mm indicator mark 504A on the vertical edge 501B corresponds to the 6 mm indicator tooth 504B on the graduated bottom edge 511. The 5 mm indicator mark 505A on the vertical edge 501B corresponds to the 5 mm indicator tooth 505B on the graduated bottom edge 511. The 4 mm indicator mark 506A on the vertical edge 501B corresponds to the 4 mm indicator tooth 506B on the graduated bottom edge 511. The 3 mm indicator mark 507A on the vertical edge 501B corresponds to the 3 mm indicator tooth 507B on the graduated bottom edge 511.

The 2 mm indicator mark 508 on the vertical edge 501B also corresponds to the indicator tooth 502B at the deepest part of the graduated bottom edge 511. When folded into the cog shape for the tread depth indicator, the 8 mm indicator tooth 502B is contiguous with the 8 mm indicator mark 502A on the vertical edge 501B and with the 2 mm indicator mark 508 on the vertical edge 501B such that the 8 mm indicator tooth 502B and the 2 mm indicator tooth 508 are the top and bottom positions of the same indicator tooth. In use, the cog shaped indicator on a new tire with the entire cog and all of the indicator teeth visible signifies the tire tread depth is 8 mm, and when all of the indicator cog segments have worn away and only the 2 mm/8 mm indicator tooth remains, this signifies that the tire tread depth is 2 mm.

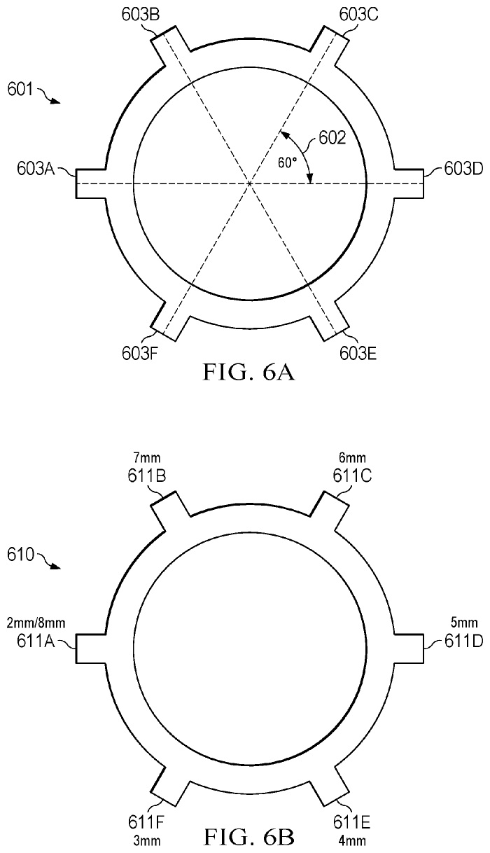

FIG. 6A shows the cog shaped tread depth indicator 601 with the indicator teeth 603A-603F equally spaced around the circumference of the indicator cog. The arc line 602 shows that each indicator tooth is spaced at a 60 degree interval around the circumference of the tread depth indicator 601.

FIG. 6B shows the tread depth indicator 610 with six equidistant indicator teeth around the circumference and the depth of the remaining tread associated with each indicator tooth. The indicator tooth 611A at the full tire tread depth of 8 mm is also the indicator tooth for when the tire tread has worn down to 2 mm or less of remaining tread depth. When the indicator tooth 611A is visible as part of an entire tread depth indicator cog, the tire tread depth is 8 mm. When only the indicator tooth 611A is visible and no other part of the tread depth indicator cog remains, the tire tread has a has worn away to a depth of 2 mm or less.

As the tire tread wears away, cog segments and indicator teeth of the tread depth indicator cog gradually disappear in a clockwise manner starting from the edge of the 2 mm/8 mm indicator tooth 611A nearest the 7 mm indicator tooth and moving in a direction around the indicator cog leading back to indicator tooth 611B. The fewer indicator teeth visible on the tread block, the less the depth that remains for the tire tread. Indicator tooth 611B corresponds to 7 mm of tread depth remaining. Indicator tooth 611C corresponds to 6 mm of tread depth remaining. Indicator tooth 611D corresponds to 5 mm of tread depth remaining. Indicator tooth 611E corresponds to 4 mm of tread depth remaining. Indicator tooth 611F corresponds to 3 mm of tread depth remaining. When 3 mm indicator tooth 611F is no longer visible, the tire tread is nearing the end of safe usability. When only the indicator tooth 611A is visible and no other part of the tread depth indicator cog remains, the tire tread has a has worn away to a depth of 2 mm or less and should be replaced. When no part of the tread depth indicator cog is visible on the tread block surface, the tread depth is 1 mm or less and the tire is no longer safe to use.

When a tire is manufactured, a variety of materials, including rubber, chemicals, metals, pigments, oils, and textiles, are specially processed and formed into multiple individual base layers having plies and belts for support of the finished tire. Each layer provides a specific function to the tire, such as strength, puncture resistance, or weather protection. The tire is constructed on a tire building machine with the base layers and sidewalls materials added over an inner liner in a series of coordinated steps, and a final layer of rubber tread material is fused to the base tire. No tread pattern has been applied to the tire and the layers are not yet bonded together. At this point, the tire is called a “green” tire, and in the next production step of curing and vulcanization, the tread pattern will be molded into the tread material and the layers will be fully bonded together.

For the curing and vulcanization process, the green tire is placed in a tread mold that has the tread pattern formed in negative (reverse image) on the mold interior. Raised tread pattern forming members on the mold interior define sidewalls for tread block sectors. These raised tread pattern forming members will form the grooves on the finished tread surface. These grooves are channels across the tread surface and define the sidewalls of raised tread blocks and any other raised features, such as stone ejectors, on the finished tire tread surface. Sipes, which are smaller grooves on the tread block surface, may be molded into the tread block surface using smaller tread forming members or sipes may be cut into the tread block surface after the molding process is completed. Sidewall patterns for the tire sidewalls are molded into the tire in the same way during curing and vulcanization.

Tread molds are made of materials that can withstand the heat and pressure required for tread molding, typically metals such as steel or aluminum. Tread molds can be two-piece assemblies with an upper mold and a lower mold having the raised tread pattern formed on the upper and lower mold surfaces, or tread pattern elements can be formed on smaller mold segments that arc cohesively secured together into a mold assembly. Tread pattern forming elements for tread molding are formed on the mold surface through a variety of processes including, but not limited to, engraving the pattern elements on the mold surface, casting the tread pattern elements in a mold, and creating the tread pattern elements for the mold using metal additive manufacturing, also called 3D metal printing.

Once the green tire is secured in the patterned mold, the tire is heated to soften the material of the tread layer for molding and an expansion bladder applies pressure to expand the green tire and force the tread material against the tread pattern elements on the mold interior causing the tread pattern to be molded into the tread material. After the tread pattern has been molded into the tread surface, the tire is held for a prescribed period of time at a predetermined temperature and pressure to complete the curing and vulcanization of the tire materials.

Curing and vulcanization of the rubber tire components is accomplished by high heat and pressure applied to the tire in the mold resulting in chemical and physical changes to the rubber materials in the tire. In this process, the rubber components of the green tire are transformed into the strong clastic rubber material needed for a tire and the multiple individual layers of the green tire are permanently bonded together into the finished tire. After the prescribed period of time, the tire is considered cured and the finished tire having the desired tread pattern is removed from the mold and inspected.

A tread pattern is added to a tire in a manner similar to the way a pattern is formed on a waffle with a waffle iron. A flexible material is pressed against a hot metal plate having raised design elements on its surface, and when removed from the mold, the design on the mold will be embedded into the tire surface in a reversed imprinting. Tread patterns in the mold are a negative of the tread pattern, with raised areas in the mold resulting in grooves on the finished tire tread. In the curing molds, arcas that are tread blocks forming sectors are separated by raised lateral and circumferential tread pattern forming elements that form the side walls of the finished tread blocks.

Tread pattern forming elements in the mold will have different heights, lengths and widths that will form the grooves of the tire tread pattern. Raised tread blocks form when the heated rubber tread material is forced around the raised tread pattern forming elements of the mold and fills the tread block forming sectors between the tread pattern forming elements with the softened rubber tread material. When the tire is cured and released from the mold, the tread blocks will be raised areas on the tire tread pattern with the circumferential and lateral grooves surrounding the raised blocks elements. Sipes appear as smaller grooves in the surface of the tread block.

Tire tread patterns as viewed on a tire have combinations of raised tread blocks, circumferential ribs of raised tread blocks, and a multitude of grooves distributed over the road contact area of the tread surface. Grooves are oriented on the tread pattern multi-directionally over the tread surface to provide specific features to the finished tire, such as channeling water away from the tire. Sipes formed into the tread block surfaces and raised stone ejectors in the grooves can be included as additional design features for a tread pattern. All of these design elements are arranged in patterns that provide the desired features and appearance to the finished tires.

Tread patterns can be made with features for specific functions, such as for weather conditions, seasons, terrain, and vehicle type. Tread patterns can also have design features for aesthetic purposes. Tread patterns usually have both functional and aesthetic components in the designs. Molded tread features desired for the finished tire tread pattern must be incorporated into the design of the tread pattern in the curing mold. The disclosed tread depth indicator is a functional element for a tire tread pattern that is incorporated into the design of a tread pattern in the tread curing mold. The tread depth indicator functional element can be incorporated into any tread pattern that has raised tread elements.

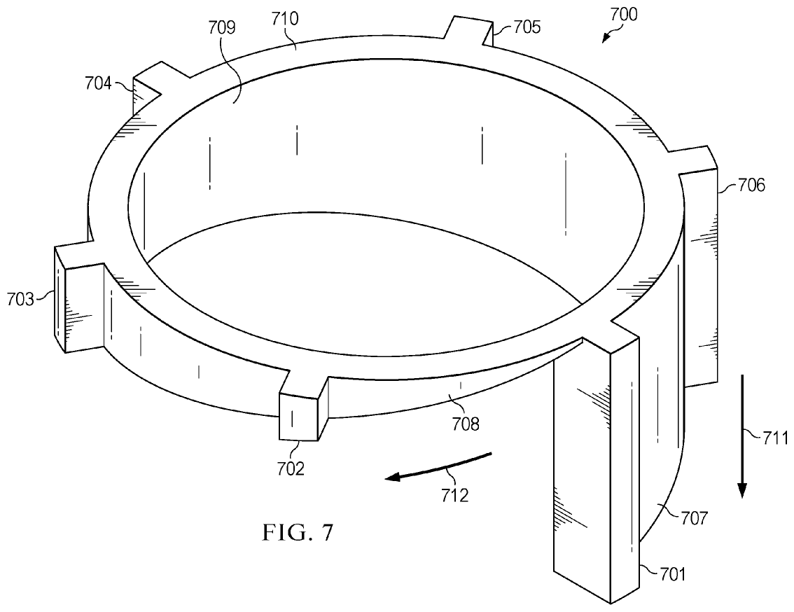

The disclosed tread depth indicator is a functional feature that is incorporated into the curing mold for a tire tread pattern and is molded into the material of the tread layer of the tire along with the tread pattern. FIG. 7 is one embodiment of a shape for a tread depth indicator mold 700 for imprinting the indicator as a groove space into a tire tread block. The tread depth indicator has a cylindrical shape with an incrementally changing height outer wall with a plurality of gradient gauge marks distributed around the shape. The tread depth indicator mold 700 is a raised solid member that is seated in one or more tread block forming sectors in the center portion of a tread pattern mold. The tread depth indicator mold is formed of the same type of material as the raised tread pattern forming members in the tread pattern mold.

The circular edge 710 seen on the tread depth indictor 700 shape is a groove pattern base and would be seated flush with the surface of the tread mold in a tread block forming sector. Arrow 711 indicates the direction the molding element would be embedded into the tread material during molding and curing. When viewed on the tread block surface of a finished tire, the tire tread depth indicator would appear as a complete cog shape (as seen in FIG. 1) with the gradient gauge marks appearing as indicator teeth equally distributed around the cog. On the finished tire, the interior of the cog is a groove space that incrementally deepens and the incrementally descending walls of the tread depth indicator are formed in the tread block material. The deepest part of the molded shape as molded into a tire will be 8 millimeters (mm) as formed by the mold indicator tooth 701.

As seen in FIG. 7, the tread depth indicator mold 700 is a cylindrical shape with an incrementally changing height outer wall having a plurality of gradient gauge marks distributed around the shape. The gradient gauge marks are mold indicator teeth 701-706 that increase in depth in a clockwise manner 712 around the circumference of the cylinder shape. The deepest mold indicator tooth 701 has a depth of 8 mm and is immediately adjacent to mold wall segment 708 which is the shallowest segment of the indicator shape. The wall segment 709 is at about the halfway point of the mold. The deepest wall segment 707 between mold indicator teeth 706 and 701 (8 mm) incrementally deepens to about the 6 mm point where it meets at mold indicator tooth 701.

On a tire, the wall segments and indicator teeth of the tread depth indicator arc molded as a groove space into a raised tread element on the tire tread surface with each of the mold indicator teeth of the tread depth indicator having made an indicator tooth of the relevant depth and each wall segment molded between each indicator tooth having a depth change that is incremental to the change in depth between the two indicator teeth adjacent to the wall segment. A tire tread block wears down over time from road contact and a tread depth indicator molded into the tread block will incrementally wear away in a clockwise direction 712 at the same rate that the tire tread block wears down. A user can view the tread depth indicator as molded into the tire tread surface and visually assess the amount tread depth remaining based on the number of indicator teeth remaining. A full indicator cog shape with all of the indicator teeth visible signifies the tire has the full tread depth. If only the last indicator tooth remains visible, the tread depth of the tire is substantially diminished, and the tire should be replaced very soon.

In use on a tire, the wall segments and indicator teeth of the tread depth indicator as molded into the tire tread will wear down at the same rate as the raised tread elements, and the indicator tooth remaining visible on the edge of the worn segment of the cog shape gauges the remaining tread depth. The indicator tooth impression made from mold indicator tooth 702 has a depth of 1 mm, and the impression from mold wall segment 708 incrementally deepens from about 0.1 mm at indicator tooth 701 to a depth of 1 mm at indicator tooth 702. In use, when the cog wall segment between indicator teeth 701 and 702 is no longer visible this indicates 7 mm of tread depth remains. Each of the molded wall segments increase in depth by 1 mm between the adjacent indicator teeth. The indicator tooth impression made from mold indicator tooth 703 has a depth of 2 mm, and in use, when the cog wall segment between indicator teeth 702 and 703 is no longer visible this indicates 6 mm of tread depth remains. The indicator tooth impression made from mold indicator tooth 704 has a depth of 3 mm, and in use, when the cog wall segment between indicator teeth 703 and 704 is no longer visible this indicates 5 mm of tread depth remains.

In like manner, the indicator tooth impression made from mold indicator tooth 705 has a depth of 4 mm, and in use, when the cog wall segment between indicator teeth 704 and 705 is no longer visible this indicates 4 mm of tread depth remains. The indicator tooth impression made from mold indicator tooth 706 has a depth of 5 mm, and in use, when the cog wall segment between indicator teeth 705 and 706 is no longer visible this indicates 3 mm of tread depth remains. The indicator tooth impression made from mold indicator tooth 701 has a depth of 8 mm which is 2 mm deeper than wall section 707. In use, when the cog wall segment 707 between indicator teeth 706 and 701 is no longer visible and only indicator tooth 701 is visible, this indicates 2 mm or less of tread depth remains. When the last indicator tooth 701 is no longer visible, this indicates that less than 1 mm of tread depth remains.

Passenger car tires should be replaced when the remaining tread depth is about 1.6 mm. If the tread depth of the tires is less than 1.6 mm, the ability of the tires to grip the road when stopping or to safely navigate wet roads is greatly decreased. A user can view the tread depth indicator on the tire tread surface and quickly visually assess the amount of tread depth remaining based on the number of indicator teeth that are visible. If the entire tread depth indicator cog is visible, the tire has the full 8 mm tread depth. If half of the tread depth indicator is missing then about half of the tread depth remains. If only the last indicator tooth is visible, 2 mm or less of tread depth remains and the tire needs to be replaced very soon. Acceptable minimum tread depth for other types of vehicles may be more than the 1.6 mm replacement recommendation for passenger car tires, and tread depth indicators for these other types of tires will incorporate the applicable depth gauges.

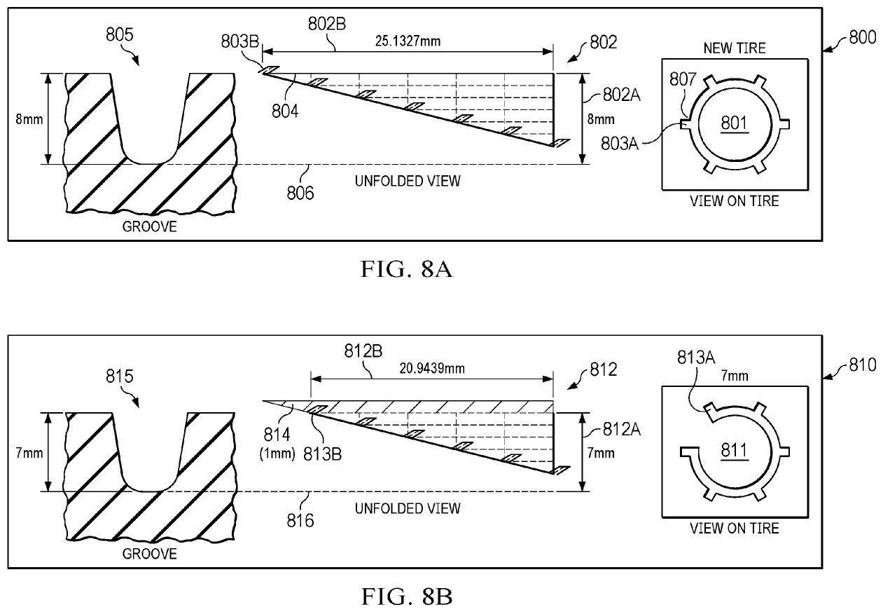

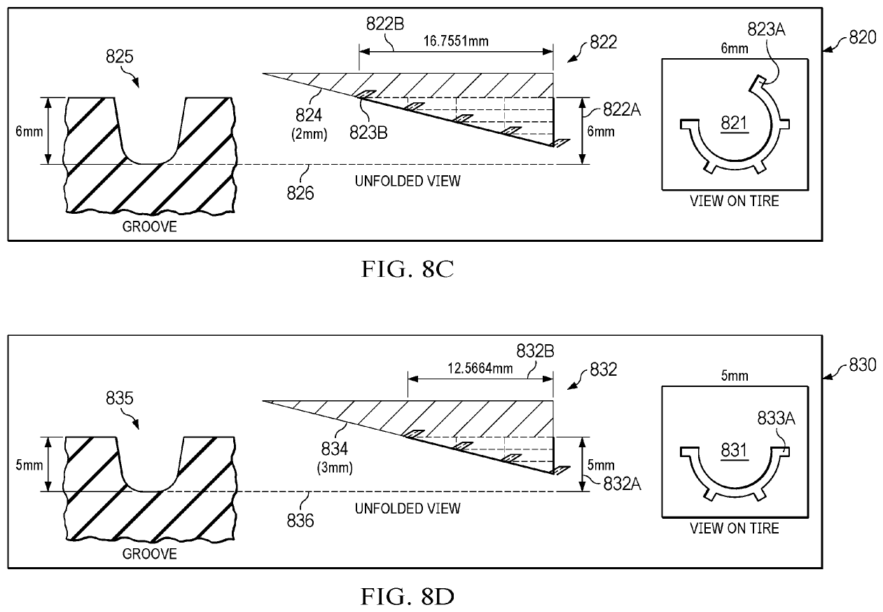

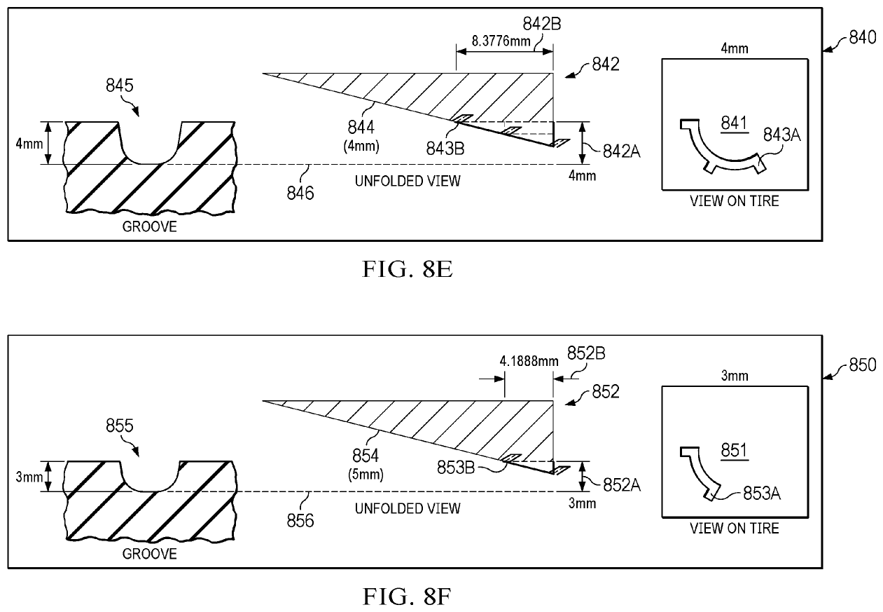

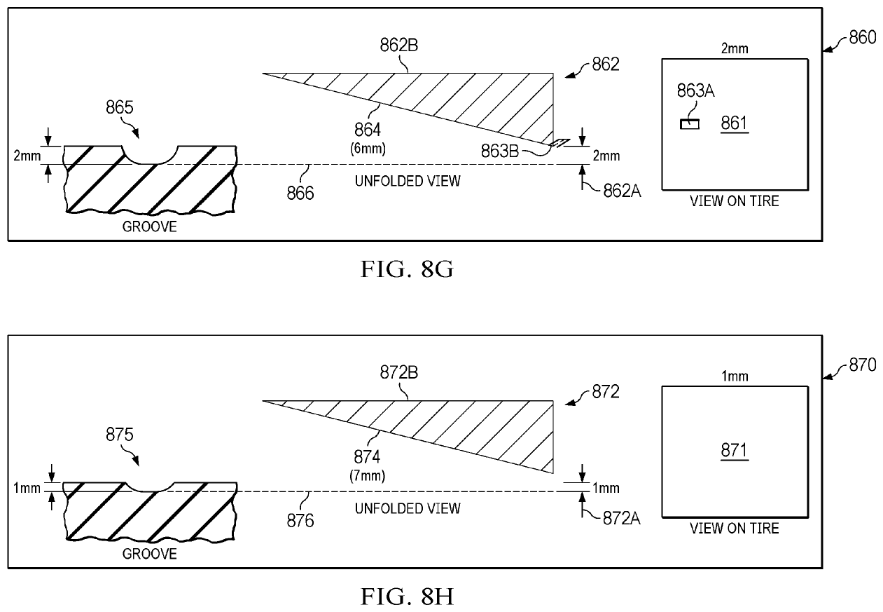

FIGS. 8A-8H are explanatory graphics that show phases of the tread depth indicator in use from a new tire having no wear to the tire tread pattern, through multiple stages of wear up to the point when the tire tread depth is exhausted. In this embodiment, the depth/height and length measurements shown on the figures are for a tire tread having a tread depth of 8 mm, which is commonly used for passenger car tires. For passenger car tires, the tires are generally deemed unsafe and in need of replacement when the tread depth reaches 1.6 mm (which corresponds to 2/32 inch). In other embodiments, the length and depth of the tread depth indicator may vary depending on the size, type, and use of the tire. For example, a semi-trailer truck tire may require the tread depth to be substantially more than 8 mm and the point of wear depth requiring replacement of the tire may be substantially more than 2 mm for drive tires. In such an embodiment, the length will be commensurate to the wear ratio for the tread depth.

FIG. 8A is a new tire graphic 800 showing the tread depth indicator with no wear to the tread pattern. The tread depth indicator 801 is a view of the indicator as it appears on a new tire with a complete cog having all six of the indicator teeth and all six segments between the indicator teeth visible. The 8 mm indicator tooth 803A corresponds to the deepest point on the indicator cog. Immediately adjacent to the clockwise edge of indicator tooth 803A is the shallowest point 806 on the tread depth indicator. This shallow point 807 has a depth of less than 1 mm.

Wearing away of the tread depth indicator will start from the shallowest point 806 adjacent to the 8 mm indicator tooth 803A and proceed in a clockwise direction around the cog of the tread depth indicator ending back at the 8 mm indicator tooth. When the 8 mm tooth is visible, along with all of the cog segments and all of the indicator teeth, the tire tread depth is the full 8 mm. When only the 8 mm tooth is visible and none of the cog is visible, the remaining tire tread depth is 2 mm or less.

Unfolded view 802 shows that the tread depth indicator shape has the full depth 802A of 8 mm and the full length 802B of 25.1327 mm. The dashed lines seen in the unfolded shape interior indicate the correspondence of the indicator teeth on the horizontal lines to show the related depth across the unfolded view of the tread depth indicator. The indicator tooth 803B on the unfolded view corresponds to the indicator tooth 803A positioned on the tread depth indicator cog 801. The top edge of the shape 804 is entire showing that no wear has yet occurred. Groove 805 shows a cross-section of the tread depth indicator and groove depth line 806 illustrates how the bottom depth of the groove 805 corresponds to the 8 mm vertical depth/height 802A shown on the unfolded view 802.

FIG. 8B is a 7 mm graphic representation 810 showing approximately 1 mm of wear to the tire tread. The 7 mm tread depth indicator 811 is a view of the indicator cog as it appears on a tire with 1 mm wear to the tire tread. A segment of the cog shape is worn away from the 8 mm indicator tooth (803A in FIG. 8A) up to the 7 mm indicator tooth 813A, which is a visual indication that 7 mm of tread depth remains.

Unfolded view 812 shows that the tread depth indicator shape has a remaining depth 812A of 7 mm and a remaining length 812B of 20.9439 mm demonstrating that a portion of the length has been worn away. The indicator tooth 813B on the unfolded view corresponds to the 7 mm indicator tooth 813A positioned on the tread depth indicator cog 811. The wear edge 814 at the top of the unfolded view shows that 1 mm of the tire tread has been worn away, and this wear is indicated by the diagonal lines across the unfolded view 812 encompassing the area between 8 mm to 7 mm across the top of the unfolded view. Groove 815 shows a cross-section of the tread depth indicator and groove depth line 816 illustrates how the bottom depth of the groove 815 corresponds to the 7 mm vertical depth/height 812A shown on the unfolded view 812.

FIG. 8C is a 6 mm graphic representation 820 showing approximately 2 mm of wear to the tire tread. The 6 mm tread depth indicator 821 is a view of the indicator cog as it appears on a tire with 2 mm wear to the tire tread. An additional segment of the cog shape is worn away from the 7 mm indicator tooth (813A in FIG. 8B) up to the 6 mm indicator tooth 823A, which is a visual indication that 6 mm of tread depth remains.

Unfolded view 822 shows that the tread depth indicator shape has a remaining depth 822A of 6 mm and a remaining length 822B of 16.7551 mm demonstrating that more of the length has been worn away. The indicator tooth 823B on the unfolded view corresponds to the indicator tooth 823A positioned on the tread depth indicator cog 821. The 7 mm indicator tooth is no longer visible. The wear edge 824 at the top of the unfolded view 822 shows that 2 mm of the tire tread has been worn away, as seen by the increase in the diagonal lines over FIG. 8B encompassing the area from 8 mm to 6 mm. Groove 825 shows a cross-section of the tread depth indicator and groove depth line 826 illustrates how the bottom depth of the groove 825 corresponds to the 6 mm vertical depth/height 822A shown on the unfolded view 822.

FIG. 8D shows a 5 mm graphic representation 830 showing approximately 3 mm of wear to the tire tread. The 5 mm tread depth indicator 831 is a view of the indicator cog as it appears on a tire with 3 mm of wear to the tire tread. Three segments of the cog shape are now worn away, showing here the wear from the 6 mm indicator tooth (823A in FIG. 8C) up to the 5 mm indicator tooth 833A, which is a visual indication that 5 mm of tread depth remains.

Unfolded view 832 shows that the tread depth indicator shape has a remaining depth 832A of 5 mm and a remaining length 832B of 12.5664 mm demonstrating that another portion of the length has been worn away. The indicator tooth on the 5 mm dashed line of the unfolded view corresponds to the 5 mm indicator tooth 833A positioned on the tread depth indicator cog 831. The 6 mm indicator tooth is no longer visible. The wear edge 834 at the top of the unfolded view shows that 3 mm of the tire tread has been worn away, as indicated by the increase in the diagonal lines which encompass the area between 8 mm and 5 mm. Groove 835 shows a cross-section of the tread depth indicator and groove depth line 836 illustrates how groove 835 corresponds to the 5 mm vertical depth/height 832A shown on the unfolded view 832.

FIG. 8E is a 4 mm graphic representation 840 showing approximately 4 mm of wear to the tire tread. The 4 mm tread depth indicator 841 is a view of the indicator cog as it appears on a tire with 4 mm of wear to the tire tread. An additional segment of the cog shape is worn away from the 5 mm indicator tooth (833A in FIG. 8D) up to the 4 mm indicator tooth 833A, which is a visual indication that 4 mm of tread depth remains.

Unfolded view 842 shows that the tread depth indicator shape has a remaining depth 842A of 4 mm and a remaining length 842B of 8.3776 mm demonstrating that another portion of the length has been worn away. The indicator tooth 843B on the unfolded view corresponds with the 4 mm indicator tooth 843A positioned on the tread depth indicator cog 841. The 5 mm indicator tooth is no longer visible. The wear edge 844 at the top of the unfolded view shows that 4 mm of the tire tread has been worn away, as indicated by the increase in the diagonal lines over FIG. 8D encompassing the area between 8 mm and 4 mm across the top of the unfolded view. Groove 845 shows a cross-section of the tread depth indicator and groove depth line 846 illustrates how the bottom depth of the groove 845 corresponds to the 4 mm vertical depth/height 842A shown on the unfolded view 842.

FIG. 8F is a 3 mm graphic representation 850 for approximately 5 mm of wear to the tire tread. The 3 mm tread depth indicator 851 is a view of the indicator cog as it appears on a tire with 5 mm of wear to the tire tread. An additional segment of the cog shape is worn away from the 4 mm indicator tooth (843A in FIG. 8E) up to the 3 mm indicator tooth 853A, which is a visual indication that 3 mm of tread depth remains.

Unfolded view 852 shows that the tread depth indicator shape has a remaining depth 852A of 3 mm and a remaining length 852B of 4.1888 mm demonstrating that another portion of the length has been worn away. The indicator tooth 853B on the unfolded view corresponds to the 3 mm indicator tooth 853A positioned on the tread depth indicator cog 851. The 4 mm indicator tooth is no longer visible. The wear edge 854 at the top of the unfolded view shows that 5 mm of the tire tread has been worn away, as indicated by the increase in the diagonal lines encompassing the area between 8 mm and 3 mm across the top of the unfolded view. Groove 855 shows a cross-section of the tread depth indicator and groove depth line 856 illustrates how the bottom depth of the groove 855 corresponds to the 3 mm vertical depth/height 852A shown on the unfolded view 852.

FIG. 8G is a 2 mm graphic representation 860 for approximately 6 mm of wear to the tire tread. The 2 mm tread depth indicator 861 is a view of the indicator cog as it appears on a tire with 6 mm of wear to the tire tread. The final segment of the cog shape is worn away from the 3 mm indicator tooth (853A in FIG. 8F) up to the 2 mm indicator tooth 863A with only the indicator tooth remaining visible, which is an indication that 2 mm of tread depth remains.

The 2 mm indicator tooth 863A seen in indicator 861 with all of the cog segments worn away is the remaining portion of the 8 mm indicator tooth 803A (which is at the top portion of the indicator tooth) as shown in the full cog tread depth indicator 801 of FIG. 8A. The tread depth indicator has worn away starting from the 8 mm indicator tooth in a clockwise direction around the indicator cog of the tread depth indicator. As each indicator tooth is worn away, the height of the indicator tooth 803A decreases by 1 mm and when only the one indicator tooth remains, the remaining tread depth is 2 mm at the 2 mm indicator tooth 863A, which is also the bottom portion of the 8 mm indicator tooth. When the 8 mm tooth and all of the cog is visible, the tread depth is the full 8 mm. When only the 8 mm indicator tooth 803A remains and none of the cog segments are visible, this indicator tooth is now the 2 mm indicator tooth 863A and the tread depth is 2 mm or less.

Unfolded view 862 shows that the tread depth indicator shape has a remaining depth 862A of 2 mm and there is no measurable length remaining (shown at 862B) demonstrating that all segments along the length have been worn away with only the one 2 mm indicator tooth 863B remaining. The indicator tooth 863B on the unfolded view corresponds to the indicator tooth 863A positioned on the tread depth indicator cog 861. The 3 mm indicator tooth is no longer visible. The wear edge 864 of the unfolded view shows that 6 mm of the tire tread has been worn away, as shown by the diagonal lines encompassing all of the original area except for the final indicator tooth 863B. Groove 865 shows a cross-section of the tread depth indicator and the groove depth line 866 illustrates how the bottom depth of the groove 865 corresponds to the 2 mm height/depth 862A as shown on the unfolded view 862.

FIG. 8H is a 1 mm or less graphic representation 870 for 7 mm or more of wear to the tire tread. In view 871, none of the indicator teeth or cog segments are visible, indicating that essentially the full depth of the tire tread has worn away.

Unfolded view 872 shows that the tread depth indicator has 1 mm or less tread depth 872A remaining and no length remaining (shown at 872B) signifying that all of the segments along the length have been worn away. None of the indicator teeth are visible. The unfolded tread depth indicator shape is fully covered by the diagonal lines at the wear edge 874 indicating that all of the tire tread has been worn away and the wear encompasses all of the area of the original unfolded view. Groove 875 shows a cross-section of the tread depth indicator and groove depth line 876 illustrates how the bottom depth of the groove 875 corresponds to the 1 mm vertical height/depth 872A as shown on the unfolded view 872.

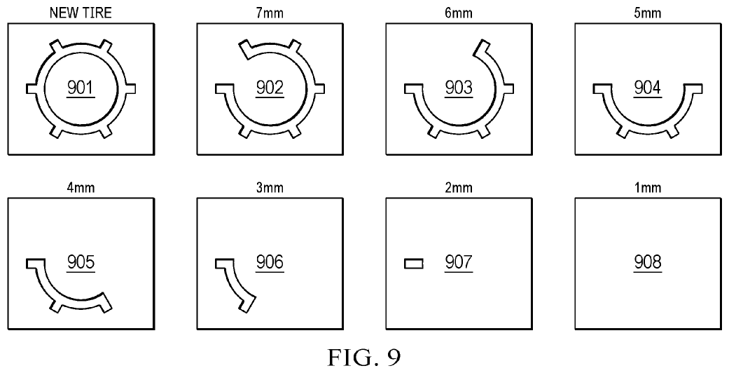

FIG. 9 is a side-by-side comparison of the cog shaped tread depth indicators from FIGS. 8A-8H showing the visibly measurable wear stages as they would be viewed on a tire tread surface. These are comparable to how a user would view the tread depth indicator on a tire to visually determine how much tread depth remains on the tire. The 8 mm tread depth indicator 901 is a full cog showing all six indicator teeth and all six segments. This is how the tread depth indicator would appear on a new tire visually indicating the tire tread is at its maximum depth. In the 7 mm tread depth indicator 902, all six indicator teeth are visible, but one segment of the cog is no longer discernable. This provides a visual indication that 1 mm of the tread depth has worn away and 7 mm of tread depth remains. The 6 mm tread depth indicator 903 shows five indicator teeth are visible, and two segments of the cog are no longer discernable. This corresponds to 2 mm of tread wear and visually indicates that 6 mm of tread depth remains. In the 5 mm tread depth indicator 904, four of the indicator teeth are visible, and three segments of the cog are no longer discernable; about half of the indicator cog is visible. This visually indicates that 3 mm of the tread depth has worn away and 5 mm of tread depth remains.

Continuing in FIG. 9, the 4 mm tread depth indicator view 905 shows three indicator teeth are visible, with only two segments of the cog remaining. This corresponds to 4 mm of tread wear providing a visual indication that 4 mm of tread depth remains. In the 3 mm tread depth indicator view 906, only two indicator teeth and one cog segment are still visible. This indicates that 5 mm of the tread depth has worn away with only 3 mm of tread depth remaining. In the 2 mm tread depth indicator view 907, only a single indicator tooth remains-no other portion of the indicator cog is visible. This corresponds to 6 mm of tread wear and provides a visual indication that only 2 mm of tread depth remains. In the 1 mm tread depth indicator view 908, no parts of the tread depth indicator cog or indicator teeth arc discernable. At this point, 1 mm or less of the tread depth remains of the tire tread and there is no visible portion of the tread depth indicator.

While preferred embodiments of the invention have been shown and described, modifications thereof can be made by one skilled in the art without departing from the spirit and teachings of the invention. The embodiments described herein are exemplary only and are not intended to be limiting. Many variations and modifications of the invention disclosed herein are possible and are within the scope of the invention

1. A vehicle tire comprising a tire tread covering a portion of the vehicle tire, the tire tread having a vertical tread depth extending from the lower base surface of the vehicle tire to the upper tire tread surface, said tire surface making contact of the tire tread with street surfaces during normal use on the vehicle tire;
the tire tread having a visual tread depth indicator defined by a first and a second vertical boundary wall that surrounds a groove pattern, said groove pattern having a bottom surface extending from the bottom of the first and second vertical boundary walls to the top surface of first and second vertical boundary walls, said bottom surface having an incremental depth extending from the upper tire tread surface toward the lower base surface of the vehicle tire; and
said groove pattern having a plurality of indicator teeth marks positioned on said groove pattern, at least two of said indicator teeth marks sharing the same position on the groove pattern but indicating different tread depths for the tire tread based on presence or absence of other indicator teeth marks on the groove pattern.

2. The vehicle tire tread of claim 1, wherein said visual tread depth indicator and said plurality of indicator teeth marks wear away sequentially in a clockwise direction beginning immediately adjacent to a clockwise side edge of a first indicator tooth mark having a first depth when all indicator teeth are present, proceeding around the tread depth indicator back to said first indicator tooth mark having a second depth when only said first indicator tooth is present on the tire tread surface.

3. The vehicle tire tread of claim 1, wherein each of said indicator teeth marks have a specified depth determinative of a tire tread depth.

4. A tire tread depth indicator comprising:
a cog shaped indicator having incrementally descending height interior walls with a plurality of depth indicator teeth distributed around the indicator cog perimeter, said indicator cog having a first depth indicator tooth in a first cog position that gauges multiple tread depths and one or more subsequent depth indicator teeth determinative of specified tread depths positioned equidistant around the indicator cog perimeter, said tire tread depth indicator being molded into one or more raised tread elements on a tire tread surface,
said tire tread depth indicator cog has a plurality of cog segments contiguous to the plurality of depth indicator teeth, said cog segments having vertical interior walls that incrementally increase in depth spirally around a circumference of the indicator cog, said vertical interior wall material being substantially of the same material as the tire tread material;
said cog segments and said depth indicator teeth wear away sequentially around the indicator cog as the raised tread element wears away, said tread depth indicator decreasing in height at the same rate as the raised tread element; and
said tire tread depth indicator on a new tire is a full cog shape with the plurality of cog segments and depth indicator teeth visible, said sequential wear begins adjacent to said first depth indicator tooth, said first depth indicator tooth having a first tread depth measurement, said wear proceeding around the circumference of the indicator cog with said cog segments and said subsequent depth indicator teeth disappearing sequentially around the indicator cog until only the first depth indicator tooth is visible on the tire tread surface, wherein said first depth indicator tooth has a second tread depth measurement.

5. The tread depth indicator of claim 4 wherein the indicator cog shape is a half of a hollow full cylindrical shell with an incrementally descending height inner wall having a plurality of gradient gauge marks distributed around the shell for visual measurement of tread depth, said shell having a perimeter with a curved surface area of the cylindrical shell incrementally decreasing from the full height of the interior wall, said gradient gauge marks being depth indicator teeth having a depth that is contiguous with the incrementally descending height inner walls.

6. The tread depth indicator of claim 4 wherein the indicator cog segments and the depth indicator teeth wear away sequentially in a clockwise direction beginning immediately adjacent to a clockwise side edge of said first depth indicator tooth in said first cog position proceeding around the indicator cog back to said first depth indicator tooth in said first cog position, with one cog segment and one subsequent depth indicator tooth disappearing for every one millimeter of tire tread depth lost to wear.

7. The tread depth indicator of claim 4, wherein the tread depth indicator has six depth indicator teeth equally distributed around the circumference of the indicator cog and six cog segments contiguous to the depth indicator teeth around the circumference of the indicator cog, each of said depth indicator teeth having a specified depth determinative of a tire tread depth.

8. The tread depth indicator of claim 4 wherein said first depth indicator tooth has a first depth of 8 mm when a full indicator cog is visible on the tire tread surface of an unworn tire and a second depth of 2 mm when only said first depth indicator tooth of the indicator cog is visible on the tire tread surface after the raised tread element has substantially worn away.

9. The tread depth indicator of claim 4 wherein each of said subsequent depth indicator teeth have a specified depth determinative of a tire tread depth said specified depth of said subsequent depth indicator teeth being between the 2 mm and 8 mm depths of said first depth indicator tooth.

10. A molding element for a tread depth indicator comprising a tread depth indicator forming member, said tread depth indicator forming member defined by vertical boundary walls having a plurality of indicator teeth marks positioned on a groove pattern base, said indicator teeth incrementally increasing in height from a shortest indicator tooth to a tallest indicator tooth, and
said vertical boundary walls incrementally increasing in height around said tread depth forming member from an edge of said tallest indicator tooth around the perimeter of the groove pattern base in the direction of the adjacent indicator teeth and meeting at the indicator tooth, said boundary walls increase in height being contiguous with the adjacent indicator teeth.

11. The molding element of claim 10, wherein the boundary walls of the tread indicator forming member incrementally increase in height in a clockwise direction around the groove pattern base, and said indicator tooth forming members increase in height by 1 mm in a clockwise direction around the groove pattern base, such that when the tread depth indicator and tread depth indictor teeth are molded into a raised tread element on a tire tread surface, each of the molded indicator teeth increases in depth by 1 mm and each molded segment of the boundary wall incrementally increases in depth consistent with the depth of the adjacent molded indicator teeth in a clockwise direction around the tread depth indicator.

12. The molding element of claim 10, wherein the tread depth indicator forming member is positioned on a tread block molding sector on an interior mold face for molding a tread pattern onto a tire tread surface.

13. A molding element for molding a tire tread depth indicator into a tire tread surface comprising a tread depth indicator forming member having a cylindrical shape with an incrementally increasing height outer wall with a plurality of gradient gauge marks distributed around the tread depth indicator, said tread depth indicator forming member being a raised solid molding element that forms a cog shaped tread depth indicator having a plurality of depth indicator teeth distributed around the perimeter of the indicator cog.

14. The molding element of claim 13, wherein the tire tread depth indicator forming member has six indicator teeth distributed around a circumference of the indicator cog and six cog wall segments contiguous to the six indicator teeth around the circumference of the indicator cog molding element.

15. The molding element of claim 13 wherein the wall segments of the indicator cog forming member incrementally increase in height in a clockwise direction around the indicator cog, and each depth indicator tooth forming member increases in height by 1 mm in a clockwise direction around the indicator cog, such that when the tread depth indicator is molded into the raised tread elements surface, each of the indicator teeth increases in depth by 1 mm and each segment of the wall incrementally increases in depth in a clockwise direction around the tread depth indicator.

16. The molding element of claim 13 wherein the tread depth indicator forming members and the tread pattern forming members for the tread pattern mold are made by engraving, casting, or metal additive manufacturing of the molding elements.

17. The molding element of claim 13, wherein the tread depth indicator forming member is positioned on a raised tread block molding sector on an interior mold face for molding a tread pattern onto a tire tread surface.

18. A method of molding a tire tread depth indicator into a tire tread surface comprising the steps of:
providing a tire tread mold having an interior mold face, said mold face having a plurality of raised tread forming members, and a plurality of tread block sectors, said raised tread forming members defining one or more sidewalls for said tread block sectors in a tread pattern mold;
providing one or more raised tread depth indicator forming members (700), said tread depth indicator forming members having a cylindrical shape with an incrementally increasing height outer wall with a plurality of gradient gauge marks distributed around the tread depth indicator, said tread depth indicator forming member being a raised solid molding element positioned in a central area of one or more tread block sectors on the interior mold face of said tread pattern mold;
fitting a tire curing and vulcanization apparatus with the tread pattern mold having said one or more tread depth indicator forming members positioned therein;
providing an assembled uncured tire having an unmolded tread surface;
placing the assembled uncured tire in the curing and vulcanization apparatus fitted with the tread pattern mold having said one or more tread depth indicator forming members;
applying a prescribed amount of heat and pressure to the uncured tire via the curing and vulcanization apparatus for a sufficient amount of time to mold the tread pattern with the tread depth indicator onto the tread surface of the tire resulting in a cured tire with the tread pattern of grooves and raised tread blocks around the circumference of a finished tire and having one or more tread depth indicators molded into a raised tread block on the surface of the finished tire, said tire tread depth indicator visually appearing on the raised tread block surface as a cog shape having one or more indicator teeth distributed around the cog; and
removing said finished tire from said curing and vulcanization apparatus.

19. The method of claim 18 wherein the tire tread depth indicator forming member has six depth indicator teeth distributed around a circumference of the indicator cog shape and six cog wall segments contiguous to the six depth indicator teeth around the circumference of the indicator cog shape.

20. The method of claim 18 wherein said indicator cog forming member wall segments incrementally increase in height in a clockwise direction around the cog, and each depth indicator tooth forming member increases in height by 1 mm in a clockwise direction around the indicator cog, such that when the tread depth indicator is molded into the tread block surface, each of the depth indicator teeth increases in depth by 1 mm and each cog segment of the wall incrementally increases in depth in a clockwise direction around the tread depth indicator.
